(19) United States
(12) Patent Application Publication
(10) Pub. No.: US 2008/0060261 A1
(43) Pub. Date: Mar. 13, 2008

(54) Herbicide application apparatuses and application methods

(76) Inventor: David Stevenson, Troy, MT (US)

Correspondence Address: WELLS ST. JOHN P.S., 601 W. FIRST AVENUE, SUITE 1300, SPOKANE, WA, 99201, US

(21) Appl. No.: 11/895,927

(22) Filed: Aug. 28, 2007

Related U.S. Application Data
(60) Provisional application No. 60/841,450, filed on Aug. 30, 2006.

(51) Int. Cl. A01M 21/04

(52) U.S. Cl. 47/1.5

(57) ABSTRACT

Portable herbicide application apparatuses are provided that can include an application mechanism operatively coupled to opposing platforms supporting an application member, with the application mechanism configured to move the opposing platforms from a first position apart from one another to a second position proximate one another, and the surfaces of the platforms supporting the application member are substantially free of encumbrances Liquid herbicide application methods are provided which can include moving the application member from one location on the biomass to another location on the biomass while both maintaining physical contact with the biomass, and applying liquid herbicide, and/or engaging a mechanical application mechanism to apply liquid herbicide to the uppermost portion of biomass from a lowest most portion of an application member, with the application member physically contacting the biomass during the applying.

### RELATED PATENT DATA

This patent claims priority to U.S. provisional patent application 60/841,450 which was filed Aug. 30, 2006, entitled “Applicator Apparatus and Application Methods” and which is incorporated by reference herein.

### BACKGROUND OF THE DISCLOSURE

Spray-less application of herbicide can generally fall into three techniques. The first is the wiper-type technique; whereupon a wick or absorbent material is generally pulled or towed behind a drive or push type machine, such as tractor. This technique relies to a certain extent on plant height. The technique has limited terrain applicability, and the technique is not individual plant sensitive.

The second technique can utilize an absorbent pad located on the end of a handle. Herbicide can be provided to the pad and weeds are then pressed or “caned” with the pad. In certain instances this technique can be effective on rosette or ground cover plants, but is typically ineffective on larger single or multi-stemmed above ground plants.

The third technique can utilize the apparatus described in U.S. Pat. No. 5,724,765 to Wegner. Absorbent pads can be fed via a conduit from a liquid reservoir. The apparatus can be manipulated to grasp and squeeze the plant with a plurality of needles located in the pads that produce holes for the herbicide to penetrate. Typical apparatuses have pads with small surface area so that the larger the plant the more difficult and ineffective the treatment. These apparatuses that utilize the grasp and squeeze technique are not suited for the treatment of rosette ground cover vegetation.

### SUMMARY OF THE DISCLOSURE

A portable herbicide application apparatus is provided that can include a liquid herbicide reservoir and an application member in fluid communication with the reservoir. The application member can be configured to physically contact biomass with a lowest most portion configured to distribute the liquid herbicide when the apparatus is held in an operative position.

The apparatus can also include a liquid herbicide reservoir operatively coupled to a regulation mechanism. The apparatus can be configured to include an application mechanism operatively coupled to opposing platforms supporting an application member, wherein the application mechanism is configured to move the opposing platforms from a first position apart from one another to a second position proximate one another. The surfaces of the platforms supporting the application member are substantially free of encumbrances

Liquid herbicide application methods are provided which can include engaging a mechanical application mechanism to both physically contact biomass with an application member at one location on the biomass, and apply liquid herbicide to the biomass at the one location. The method can include moving the application member from the one location on the biomass to another location on the biomass while both maintaining physical contact with the biomass, and applying liquid herbicide.

Methods also include engaging a mechanical application mechanism to apply liquid herbicide to the uppermost portion of biomass from a lowest most portion of an application member, with the application member physically contacting the biomass during the applying.

### BRIEF DESCRIPTION OF THE DRAWINGS

FIG. 1 is a perspective of an apparatus according to an embodiment.

FIG. 2 is another perspective of the apparatus of FIG. 1 according to an embodiment.

FIGS. 3-5 are depictions of the use of an apparatus according to an embodiment.

FIG. 6 is a configuration of an apparatus according to an embodiment.

FIG. 7 is another configuration of the apparatus of FIG. 6 according to an embodiment.

FIG. 8 is a perspective of the apparatus of FIG. 6 according to an embodiment.

FIG. 9 is a cross-section perspective of the apparatus of FIG. 8 according to an embodiment.

### DESCRIPTION

This disclosure is submitted in furtherance of the constitutional purposes of the U.S. Patent Laws “to promote the progress of science and useful arts” (Article 1, Section 8).

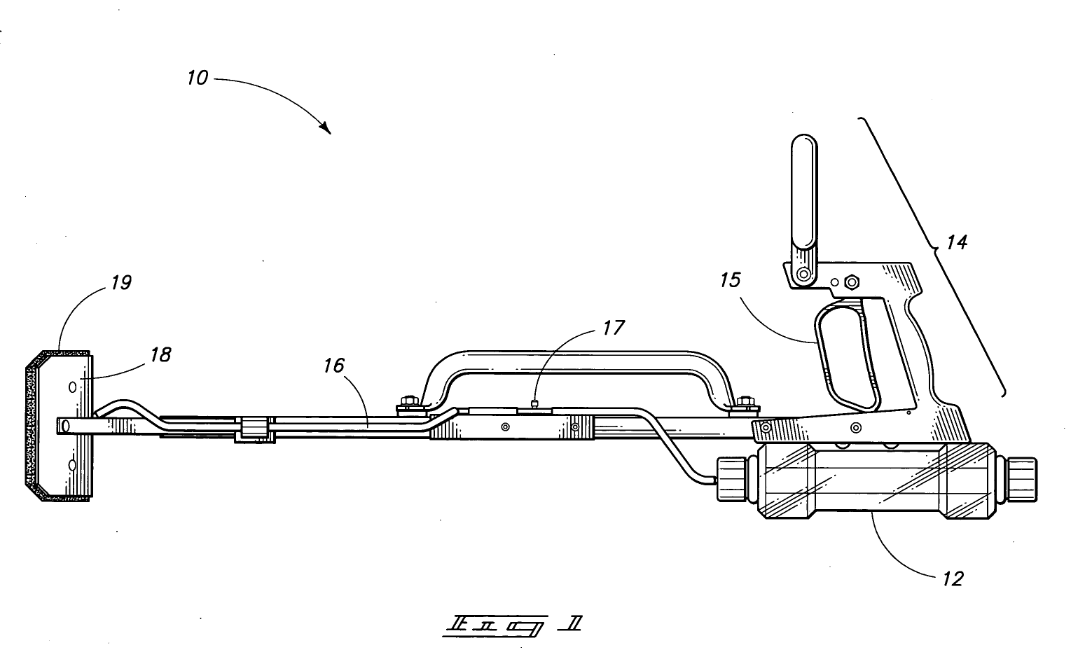

According to exemplary embodiments and referring to FIGS. 1-10, a portable herbicide application apparatus is provided whereby liquid herbicide can be delivered to the surface of a selected plant by pressing and/or swiping. Pressing can be used, for example, when plants are in the rosette stage of growth, or where a plant exhibits no above ground vegetation. Swiping can be used, for example, to treat any plant physiology that is above ground, such as those plants having stems and leaves.

The apparatus can be configured to treat a myriad of physical characteristics exhibited by various noxious weeds, including those found throughout the inter-mountain West. When configured according to example implementations, disadvantages associated with spraying a herbicide can be overcome. Some of these disadvantages associated with spraying can include the need for protective gear, the collateral damage to adjacent desirable vegetation, and any drift associated with windy conditions. Spraying can be undesirable in riparian/wet land areas and areas where sensitive and desirable seedlings are commingled with invasive noxious weeds. Herbicides that, upon achieving plant mortality to the root, then become inert in the soil, are still not selective and can destroy any vegetation they come in contact with. The apparatus can employ these highly toxic herbicides while at the same time eliminating the cautions and disadvantages associated with spraying.

Referring to FIG. 1, apparatus 10 can include liquid herbicide reservoir 12 adjacent application mechanism control member 14. Reservoir 12 can be coupled via conduit 16 to application member 19. Application member 19 can be in fluid communication with reservoir 12. Application member 19 can be supported by support platforms 18 of the application mechanism. Application member 19 may be a single substrate or at least two substrates with each substrate can be individually supported by individual platforms 18 or the application mechanism. In this configuration, member 19 can include at least two components, with a first component being supported by a first platform and a second component being supported by a second platform. Surfaces of platforms 18 can be substantially free of encumbrances, for example. Platforms 18 can have an application support surface that is configured to allow member 19 to slidably contact biomass during application.

Application member 19 can be constructed of a fibrous substrate, including but not limited to a sponge material. Example embodiments of member 19 can include materials that can retain a liquid and desorb the liquid when compressed. According to example configurations, member 19 can be configured to slidably contact biomass during application of herbicide using apparatus 10, for example. At least one configuration of apparatus 10 includes at least one of the components of member 19 being configured to slidably contact biomass during application. According to another configuration, both first and second components of member 19 can be configured to slidably contact the biomass during application.

Application member 19 may be comprised of two substrates with a first substrate coupled to the second substrate. The first substrate may be configured to adsorb/desorb liquid herbicide while the second substrate may be configured to be removably coupled to platforms 18, for example. The removable coupling of the second substrate can include a hook and loop configuration which is commonly referred to as Velcro. According to another embodiment the second substrate may include a releasable/resealable adhesive.

Platforms 18 can be operatively coupled to control member 14 forming the application mechanism, such as mechanical coupling. Platforms 18 can be opposing platforms and the application mechanism can be configured to move the opposing platforms from a first position apart from one another to a second position proximate one another. Control member 14 can include a lever grip including a trigger 15 that can be configured to manipulate a distance between application members 19 and/or compression and/or member 19 pressures during application of herbicide to various plant physiologies. Manipulations of the application mechanism can include clutching biomass between the first and second components of the application members when in the second position.

Apparatus 10 can also include a regulation mechanism 17 such as a control valve operatively coupled between reservoir 12 and application members 19. Mechanism 17 can be configured to control the amount of herbicide released from reservoir 12 to members 19. According to exemplary configurations, an operator can utilize mechanism 17 to regulate the herbicide flow. This may be desirable as dictated by the level of plant density and occurrence within the treatment area.

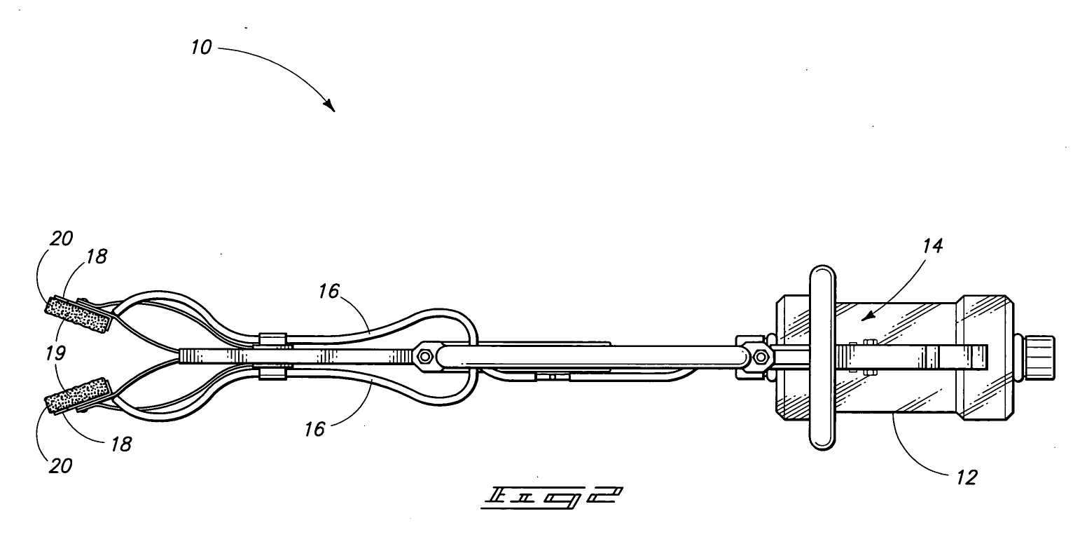

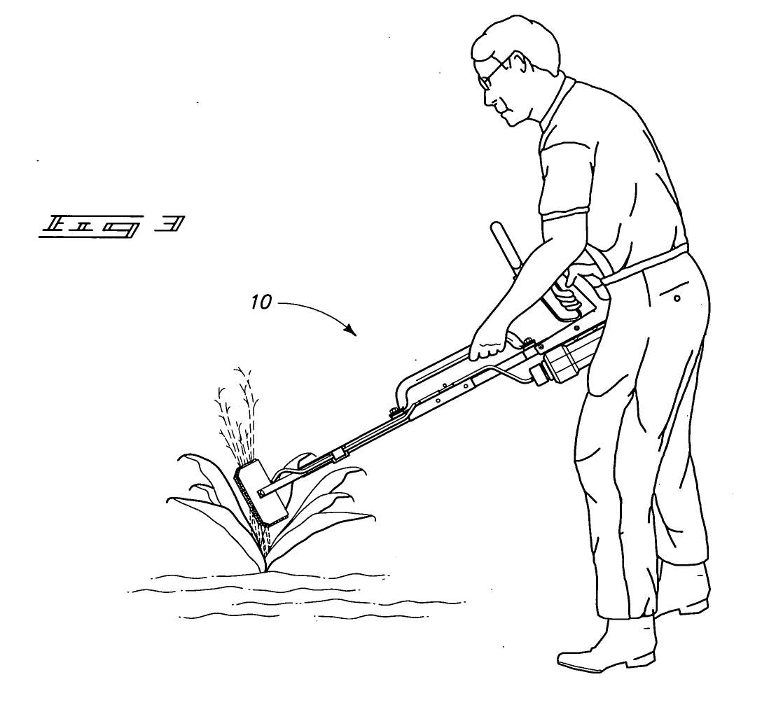

Referring to FIG. 2, members 19 can have a large surface area as compared to platforms 18. Portions 20 of members 19 can extend below platforms 18, for example. According to example implementations, portions 20 can be configured to physically contact biomass with this lowest most portion further configured to distribute the liquid herbicide when the apparatus is held in the operative position as depicted in FIGS. 3-5. When apparatus 10 is maintained in the second position, a lowest most portion of both components can extend below both platforms when apparatus 10 is held in the operative position.

Referring to FIGS. 3-5, according to exemplary configurations, the surface area of members 19 can be sufficient to clutch and/or grasp biomass at one location upon engaging the mechanical application mechanism. The application member can both physically contact the biomass and apply liquid herbicide at the one location. For example, a plant base or main stem can be contacted. The application member can be moved from the one location on the biomass to another location on the biomass while both maintaining physical contact with the biomass, and applying liquid herbicide. For example, after contacting the plant base or main stem, the apparatus can then be pulled upward. An example method can include pulling the application members off the top of the plant, and as this movement is being applied, the attached plant stems and leaves can be drawn into and pass through the application member. To facilitate this moving of the application members upon the biomass, the application members as well as the supporting platforms can be relatively free of encumbrances as described above, for example. Removal from the biomass can be completed by disengaging the mechanical application mechanism as well. Disengaging can include moving opposing platforms of the application mechanism away from one another to the biomass at the one location.

According to exemplary implementations, a complete coating of stems, leaves, buds and in some cases flowers of the plant being treated can be accomplished. In dense infestations of early to medium stage growth it can be possible to treat more than one plant at a time by “corralling” before compressing and drawing upward.

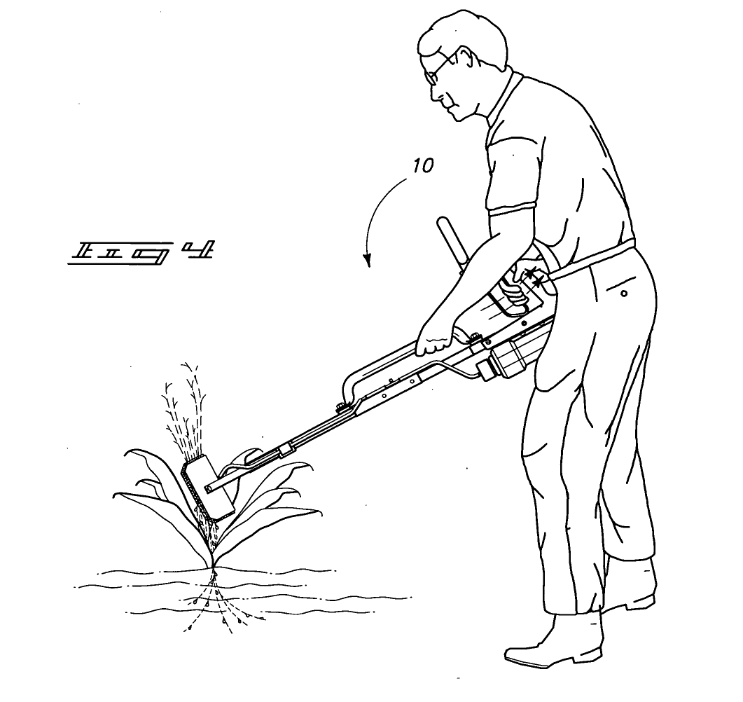

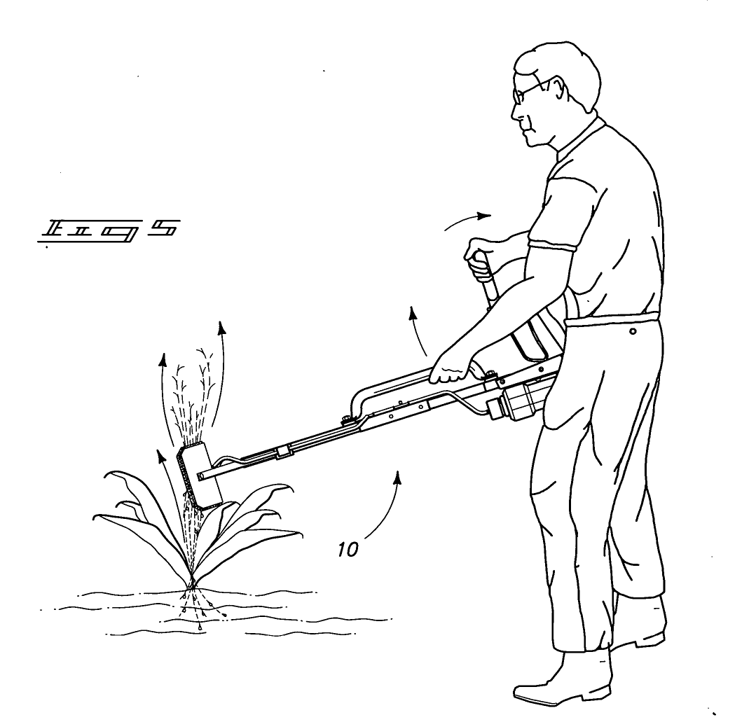

Referring to FIGS. 6 and 7, platforms 18 are shown in the open and application or closed positions. The apparatus can be used to grasp the basil stem and then pulled up and off the top of the plant. This movement can allow herbicide to be dispensed over the entire plant to include the underneath of the leaves where much of the growth function takes place. As members 19 are compressed around the main stem, a channel or vortex can be formed in members 19 so that during the upward movement the attached branches and leaves are pulled into and treated in the one movement as they pass through the formed vortex.

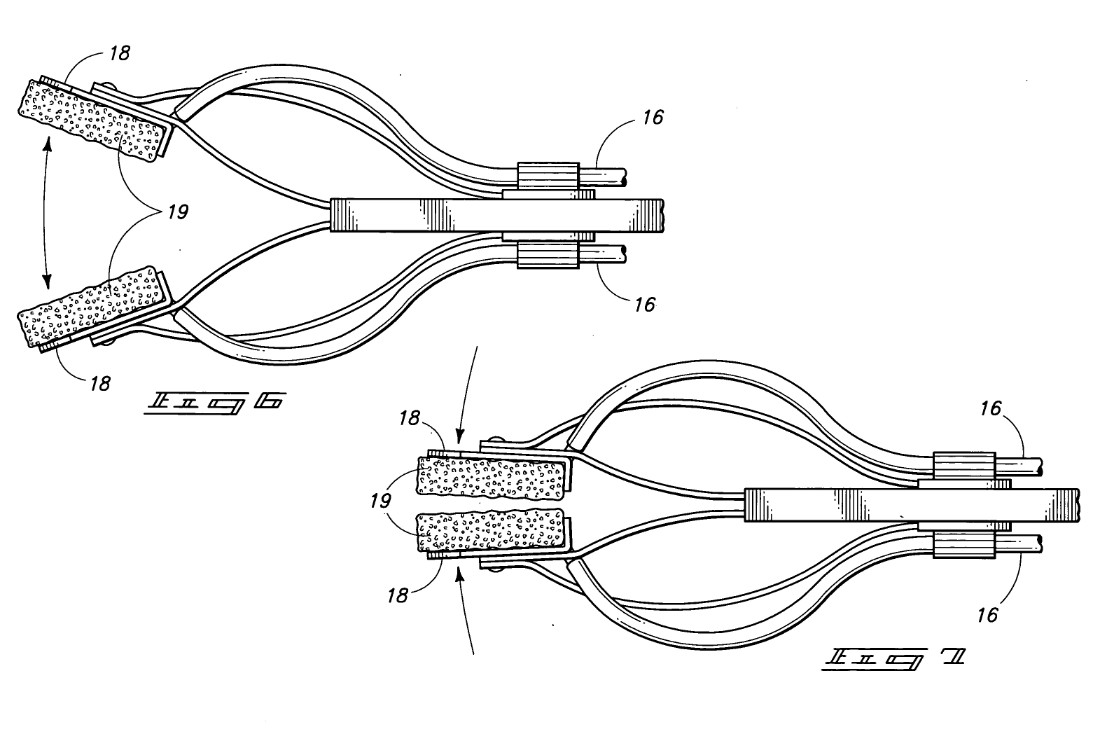

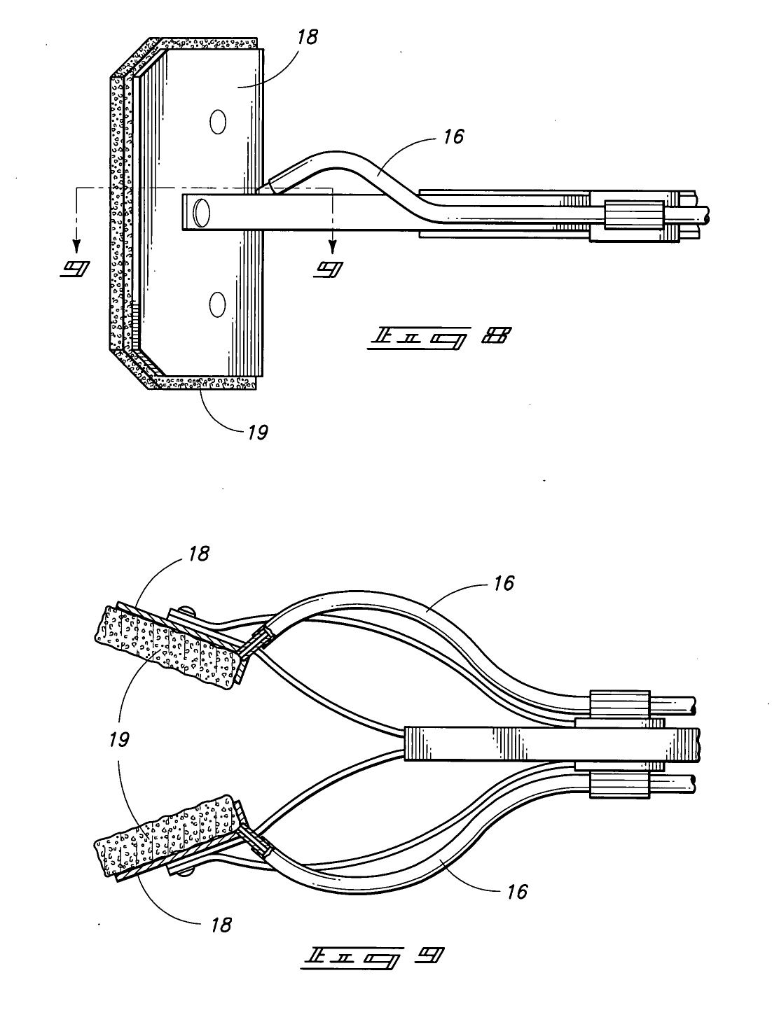

Referring to FIGS. 8 and 9, platforms 18 of apparatus 10 are shown as a cross-section 9. Members 19 are exposed at the lower portion and do not have spikes or projections from platforms 18. According to exemplary embodiments, members 19 can slide along plants stems during application without the projections.

For plants with a physiology that does not provide for above ground grasping, the apparatus can be used in a ground cover mode that then allows the use of the press or “cane” technique using the exposed lower portion of pads 19, for example. The method can include engaging the mechanical application mechanism to apply liquid herbicide to the uppermost portion of biomass from the lowest most portion of the application member with the application member physically contacting the biomass during the applying. The engaging can include moving the opposing platforms from a first position apart from one another to a second position proximate one another. In the second position, the lowest most portions of the application member can extend below the opposing platforms during the applying. Where the application member includes two components, the engaging can include compressing the components of the application members.

These two types of treatment can be accomplished by two opposing components of the application member. These components can be shielded excepting portions slightly over hang on the lowest most portion when apparatus is in the operative position as demonstrated in FIGS. 3-5 for example. The liquid herbicide can be delivered to the members by a manually operated control valve, based upon the level of production. In the relaxed position the saturated members are held apart by spring steel straps. The members can be drawn together by an operated controlled lever. The structure of a plant is considered relative to the amount of pressure applied and as the apparatus is being drawn up and over, the entire plant can be completely coated. This grasping sliding movement can be utilized on plants from emergence to late stage growth. In the case of a plant whose physiology does not allow it to be grasped the apparatus has a member lock. The members can be closed to a flush position and are held thereby by a pushpin. In this operating position the operator can press or “cane” rosettes or ground level vegetation by that portion of the member exposed on the leading edge of the pad shield. A one liter (with quart marking) container has the capacity to allow for significant distribution between refills. The length of the apparatus along with two helper handles combined with the grip in the housing can facilitate the ergonomics of substantial working use in the field. A protective cover can be employed for transporting or storage when not in use and can prevent the members from coming in contact with surrounding surfaces.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A portable herbicide application apparatus comprising:
a liquid herbicide reservoir; and
an application member in fluid communication with the reservoir, the application member configured to physically contact biomass with a lowest most portion configured to distribute the liquid herbicide when the apparatus is held in an operative position.

2. The application apparatus of claim 1 further comprising at least one platform supporting the application member, the platform being mechanically coupled to an application mechanism, wherein at least a portion of the application member extends below the platform when the apparatus is held in the operative position.

3. The application apparatus of claim 1 further comprising an application mechanism operatively coupled to opposing platforms supporting the application member, wherein the application mechanism is configured to move the opposing platforms from a first position apart from one another to a second position proximate one another.

4. The application apparatus of claim 1 wherein the application member comprises two components, a first component being supported by a first platform of the opposing platforms and a second component being supported by a second platform of the opposing platforms, a lower portion at least one of the components extending below the platforms when the apparatus is held in the operative position.

5. The application apparatus of claim 4 wherein, in the second position, a lowest most portion of both components extends below both platforms when the apparatus is held in the operative position.

6. A portable herbicide application apparatus comprising:
a liquid herbicide reservoir operatively coupled to a regulation mechanism;
an application mechanism operatively coupled to opposing platforms supporting an application member, wherein the application mechanism is configured to move the opposing platforms from a first position apart from one another to a second position proximate one another; and
wherein the surfaces of the platforms supporting the application member are substantially free of encumbrances.

7. The application apparatus of claim 6 wherein the application member is configured to slidably contact biomass during application.

8. The application apparatus of claim 6 wherein the application member comprises two components, a first component being supported by a first platform of the opposing platforms and a second component being supported by a second platform of the opposing platforms.

9. The application apparatus of claim 8 wherein at least the first component of the application members is configured to slidably contact biomass during application.

10. The application apparatus of claim 8 wherein both the first and second components of the application members are configured to slidably contact biomass during application.

11. The application apparatus of claim 8 wherein the application mechanism is configured to clutch biomass between the first and second components of the application members when in the second position.

12. The application apparatus of claim 6 wherein the application member comprises fibre.

13. The application apparatus of claim 6 wherein the application member comprises two substrates, a first substrate configured to slidably contact biomass and desorb herbicide, and a second substrate bonded to the first substrate, the second substrate configured to removably couple at least one platform of the application mechanism.

14. A liquid herbicide application method comprising:
engaging a mechanical application mechanism to both physically contact biomass with an application member at one location on the biomass, and apply liquid herbicide to the biomass at the one location;
moving the application member from the one location on the biomass to another location on the biomass while both maintaining physical contact with the biomass, and applying liquid herbicide; and
disengaging the mechanical application mechanism.

15. The method of claim 14 wherein the engaging further comprises moving opposing platforms of the application mechanism toward one another to grasp the biomass at the one location.

16. The method of claim 15 wherein the biomass is grasped during the moving.

17. The method of claim 14 wherein the disengaging further comprises moving opposing platforms of the application mechanism away from one another to release the biomass at the one location.

18. A liquid herbicide application method comprising engaging a mechanical application mechanism to apply liquid herbicide to the uppermost portion of biomass from a lowest most portion of an application member, the application member physically contacting the biomass during the applying.

19. The method of claim 18 wherein the mechanical application mechanism operatively couples to opposing platforms supporting an application member, and the engaging comprises moving the opposing platforms from a first position apart from one another to a second position proximate one another.

20. The method of claim 19 wherein the lowest most portion of the application member extends below the opposing platforms during the applying.

21. The method of claim 19 wherein the application member comprises two components, a first component being supported by a first platform of the opposing platforms and a second component being supported by a second platform of the opposing platforms, and the engaging comprises compressing the first and second components of the application member.

22. The method of claim 21 wherein at least a portion of the first component extends below the first platform during the applying.

23. The method of claim 21 wherein at least a portion of both components extends below the platforms during the applying.
